(19) United States
(12) Patent Application Publication
(10) Pub. No.: US 2019/0122487 A1
(43) Pub. Date: Apr. 25, 2019

(54) REEL-BASED WAGERING GAMES

(71) Applicant: King Show Games Inc., Minnetonka, MN (US)

(72) Inventors: Jacob Lamb, Maple Grove, MN (US); Bradley Berman, Minnetonka, MN (US)

(21) Appl. No.: 16/164,408

(22) Filed: Oct. 18, 2018

Related U.S. Application Data
(60) Provisional application No. 62/576,502, filed on Oct. 24, 2017.

(51) Int. Cl. G07F 17/32

(52) U.S. Cl. CPC G07F 17/3213; G07F 17/3244

(57) ABSTRACT

Reel-based wagering games comprise displaying spinning reels at a default spinning rate and reducing a spinning rate of a target reel from the default spinning rate toward or to a slowed spinning rate responsive to a predetermined symbol or set of symbols of the target reel being displayed or about to be displayed.

### RELATED APPLICATION

This application claims priority under 35 U.S.C. § 119(e) to U.S. Provisional Patent Application No. 62/576,502, which is entitled “REEL-BASED WAGERING GAMES,” was filed on Oct. 24, 2017, and the disclosure of which is incorporated by reference.

### FIELD

The present disclosure relates to reel-based wagering games.

### BACKGROUND

Casino games such as poker, slots, and craps have long been enjoyed for entertainment. Almost any game of chance that can be played using traditional apparatus (e.g., cards, dice) can be simulated on a computer. The popularity of casino gambling with wagering continues to increase, as does recreational gambling such as non-wagering computer game gambling. It is also likely that most new games will be implemented, at least in part, using computerized apparatus.

One reason that casino games are widely implemented on computerized apparatus is that computerized games are highly adaptable, easily configurable and re-configurable, and require minimal supervision to operate. For example, the graphics and sounds included in such games can be easily modified to reflect popular subjects, such as movies and television shows.

Computer gaming devices can also be easily adapted to provide entirely new games of chance that might be difficult to implement using mechanical or discrete electronic circuits. Because of the ubiquity of computerized gaming machines, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, in that players make wagers of value, whether actual currency or something else of value, e.g., token or credit. Wagering-type games usually provide rewards based on random chance as opposed to skill. In some jurisdictions, the absence of skill when determining awards during game play is a requirement.

The present disclosure describes methods, systems, and apparatus that provide for new and interesting gaming experiences, and that provide other advantages over the prior art.

### SUMMARY

Reel-based wagering games and associated methods and gaming apparatuses are disclosed. Examples of reel-based wagering games comprise displaying spinning reels at a default spinning rate; and reducing a spinning rate of a target reel of the spinning reels from the default spinning rate toward or to a slowed spinning rate responsive to a predetermined symbol or set of symbols of the target reel being displayed or about to be displayed in a displayed game grid.

### BRIEF DESCRIPTION OF THE DRAWINGS

FIG. 1 is a representation of example reel-based wagering games having five reels.

FIG. 2 is a representation of an example game of FIG. 1, with all five reels depicted in a changing state.

FIG. 3 is a representation of an example game of FIG. 1 in sequence with FIG. 2, with the four left-most reels depicted in stopped states, with the first and third reels leading to a possible scatter pay payout condition, and with the fifth reel depicted in a default changing state.

FIG. 4 is a representation of an example game of FIG. 1 in sequence with FIGS. 2-3, with the fifth reel depicted in a slowed changing state with a matching symbol corresponding to a possible scatter pay payout condition with the first and third reels entering the grid.

FIG. 5 is a representation of an example game of FIG. 1 in sequence with FIGS. 2-4, with the fifth reel continued to be depicted in a slowed changing state with the matching symbol leaving the grid.

FIG. 6 is a representation of an example game of FIG. 1 in sequence with FIGS. 2-5, with the fifth reel depicted in a default changing state and the matching symbol having left the grid.

FIG. 7 is a representation of an example game of FIG. 1 in sequence with FIGS. 2-6, with all five reels depicted in stopped states and with the fifth reel not displaying a matching symbol corresponding to a possible scatter pay payout condition with the first and third reels.

FIG. 8 is a representation of an example game of FIG. 1 in sequence with FIGS. 2-6, with all five reels depicted in stopped states and with the fifth reel displaying a matching symbol corresponding to a scatter pay payout condition with the first and third reels.

FIG. 9 is a representation of an example game of FIG. 1 in sequence with FIG. 2, with the four left-most reels depicted in stopped states and having matching stacked symbols displayed, and with the fifth reel depicted in a default changing state.

FIG. 10 is a representation of an example game of FIG. 1 in sequence with FIGS. 2 and 9, with the fifth reel depicted in a slowed changing state with a stack of matching symbols displayed and corresponding to a payout condition with the first four reels.

FIG. 11 is a representation of an example game of FIG. 1 in sequence with FIGS. 2, 9, and 10, with the fifth reel depicted in a default changing state and the stack of matching symbols having left the grid.

FIG. 12 is a representation of an example game of FIG. 1 in sequence with FIGS. 2 and 9-11, with the fifth reel depicted a stopped state and not resulting in an increased payout with the first four reels.

FIG. 13 is a representation of an example game of FIG. 1 in sequence with FIGS. 2 and 9-11, with the fifth reel depicted in a slowed changing state with a stack of matching symbols displayed and corresponding to a payout condition with the first four reels.

FIG. 14 is a representation of an example game of FIG. 1 in sequence with FIGS. 2, 9-11, and 13, with the fifth reel depicted in a stopped state and resulting in an increased payout with the first four reels.

FIG. 15 is a front view of an example gaming apparatus.

FIG. 16 is a block diagram representing an example computer arrangement.

### DESCRIPTION

In the following description of various exemplary embodiments, reference is made to the accompanying drawings which form a part hereof, and in which are shown by way of illustration representative embodiments in which the features described herein may be practiced. It is to be understood that other embodiments may be utilized, as structural and operational changes may be made without departing from the scope of the disclosure.

In the description that follows, the term “reels” and similar mechanically descriptive language may be used to describe various apparatus presentation features, as well as various actions occurring to those objects (e.g., “spin” and “stop”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as reels and the like may be simulated on a display in order to provide a familiar and satisfying experience that emulates the behavior of mechanical objects, as well as emulating actions that occur in non-computerized games (e.g., spinning and stopping reels). Further, a computerized version may provide the look of mechanical equivalents but may be generally randomized in a different way. Thus, the term “reel,” for example, is intended to describe both physical reels and emulation or simulations of physical reels and their behaviors using electronic apparatus.

In various embodiments, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing one symbol with another symbol. Generally, such comparisons can be performed via software by mapping numbers (or other data structures such as character strings) to the symbols and performing the comparisons on the numbers/data structures.

The games and methods disclosed herein may be implemented as a single game, or part of a multi-part game. For example, the game features disclosed herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g., slot game) are provided for purposes of facilitating an understanding of the features described herein. However, the principles described herein are equally applicable to any game of chance where an outcome(s) is determined for use in the player's gaming activity.

Reel-based wagering games and corresponding game methods are disclosed herein, with the reel-based wagering games indicated in the figures at 10 and generally referred to herein as reel-based wagering games 10, or just games 10. Reel-based wagering games 10 additionally or alternatively may be referred to as slots, video slots, slot games, slot machines, reel-based slot machines, and so forth. Games 10 may include any number of reels 12, with any number of symbols 14 associated with the reels 12. The presentation, representation, or display of a game 10 may be described as including a grid 16 of symbol positions 13, including two or more rows 18 and two or more columns 20, with individual columns 20 corresponding to individual reels 12, and with the displayed symbols 14 shown in the symbol positions 13 representing a subset of the total symbols 14 associated with all of the reels 12. The reels 12 may be displayed as stopped reels, with only a subset of symbols associated with a given reel being displayed. Additionally, the reels 12 may be displayed as changing reels, with the symbols associated with a given reel moving, such as in connection with a spinning reel in mechanical examples, or simply as changing symbols, whether simulating a mechanical reel or representing random or other representation of symbols.

In mechanical examples, the game reels 12 may include physical reel strips where game symbols 14 are shown in images fixed on the reel strips. Virtual reel strips may be mapped to these physical reel positions shown on the reel strips to expand the range or diversity of game outcomes. In video slot examples, reel strips may be encoded in a memory or database, and virtual reels may be used for the game reels with images representing the data related to the reel strips. In other slot machine embodiments, each symbol position 13 on the grid 16 may be associated with an independent reel strip. In yet other slot machine embodiments, reels and/or reel strips may not be used at all in determining the symbols shown in the symbol positions 13 of the grid. For example, a symbol 14 may be randomly selected for each symbol position 13 within the grid 16, or the symbols 14 may be determined in part by game events occurring during game play, such as displayed elements in the symbol positions 13 being replaced by new game elements or symbols. Numerous variations are possible for implementing slot-type game play.

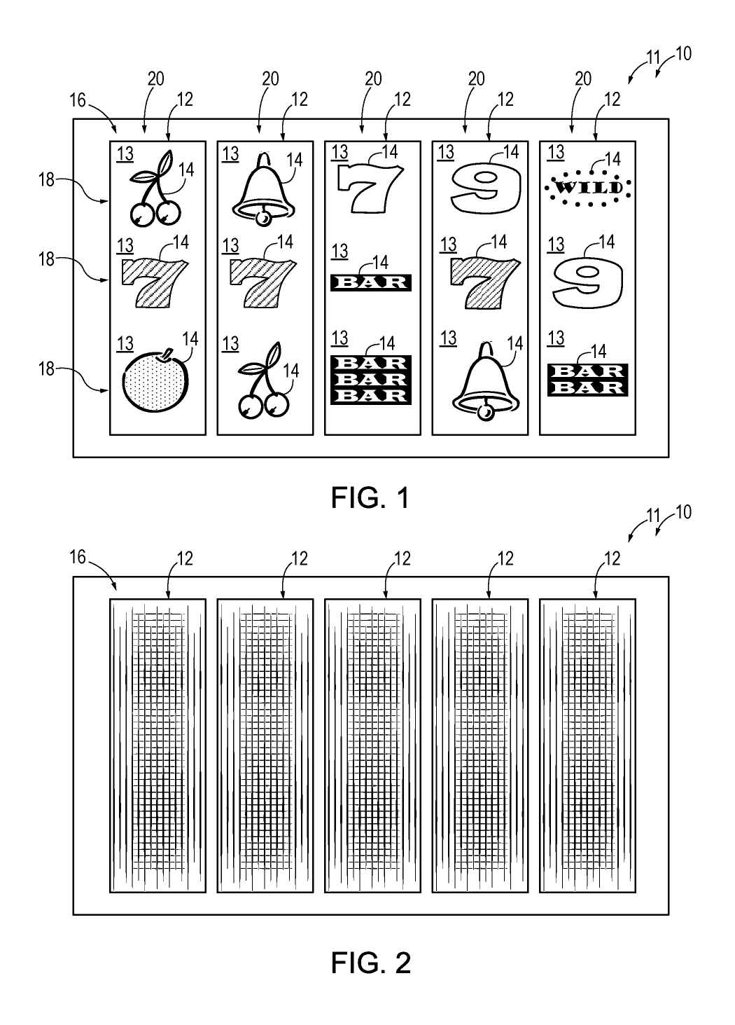

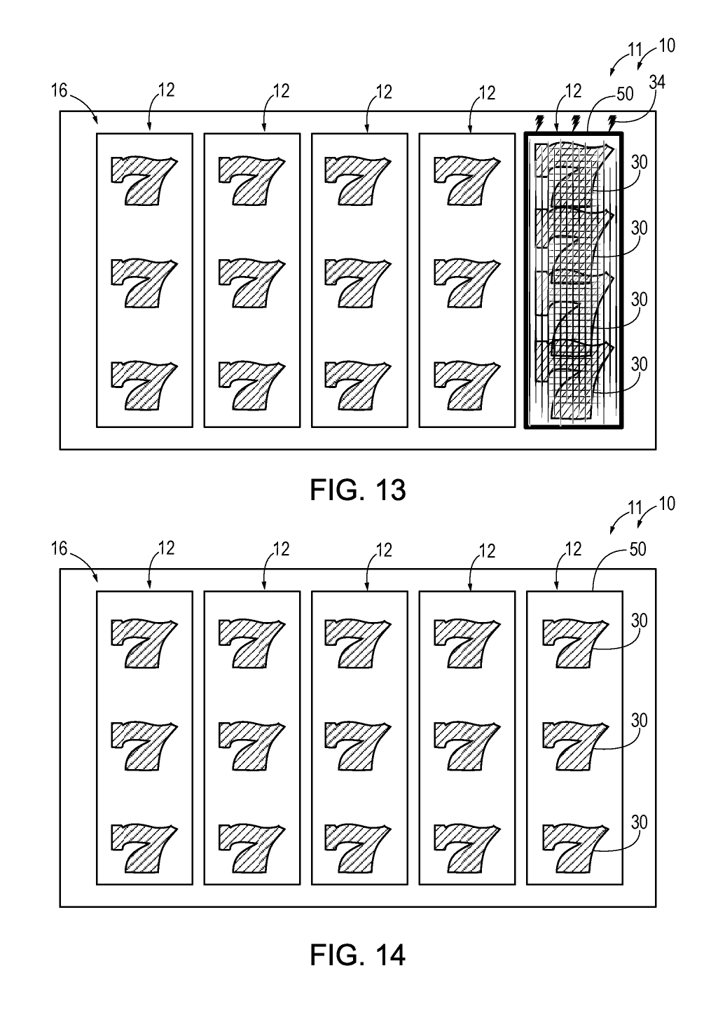

The example games 10 illustrated in FIGS. 1-14 have a grid 16 representing three rows 18 of symbols 14 from five reels 12, resulting in a total of fifteen displayed symbols 14 when all five reels 12 are stopped, and are referred to herein as games 11; however, the features of example games 11 discussed herein may be applied to games 10 having any suitable size of default grid 16 with any number of rows 18 and/or any number of reels 12.

Payout schemes associated with slots may include evaluations of symbol combinations associated with line pays along paylines, scatter pays, multi-way pays, or other types of symbol combination evaluation methods. In slot games that utilize line pays, the line payout schemes are often associated with one or more paylines, where each payline corresponds to a predetermined arrangement or combination associated with predetermined symbol positions 13 within a game's grid 16. To ascertain whether a payout condition exists for a given game outcome, the game symbols 14 within the symbol positions 13 associated with a particular payline may be evaluated to determine if a symbol combination is present that matches an entry in a paytable with an associated award. Any number of paylines may be utilized in a game 10 according to the present disclosure.

Historically, most reel-based wagering games evaluate symbol combinations starting at the left-most game reel and then proceeding to the right (“left to right paying games”), although other games may evaluate symbol combinations beginning on the right-most reel and then proceeding to the left (“right to left paying games”) or evaluate both left to right and right to left (“both way paying games”). Although left to right paying game embodiments are described below in connection with example game 11, the subject matter of the present disclosure may be used for right to left paying game embodiments or both way paying game embodiments. Historically, for left to right paying games, the games generally only payout if the left-most stopped reel has at least one symbol that initiates or begins a symbol combination associated with an award in a pay table.

In addition, reel-based wagering games that either utilize paylines or multi-way pays typically require a minimum number of sequential (i.e., directly adjacent) reels to have matching or winning symbols along a payline (or within each reel for a multi-way pay evaluation embodiment) (also referred to as “symbol combinations”) to result in a payout, with three sequential reels being a common threshold number of reels, but any number being within the scope of the disclosure. Games additionally or alternatively may use scatter pays where any symbols appearing on a game grid as part of a game outcome may be used in evaluating symbol combinations. With scatter pays, a threshold number of reels also is required to result in a payout, but the threshold number of reels may not need to be sequential or adjacent to each other. During game play of reel-based waging games, a player may become distracted or not immediately recognize a potentially good game outcome. The features of games 10 herein address this potential to miss cues for a potentially good result associated with an award by visually (and auditorily in some embodiments) building anticipation through manipulation of reel spin mechanics (whether mechanical or virtual), that is, by manipulating the visual presentation of a spinning (or otherwise changing) reel.

With the above as a framework, games 10 may be described as providing a player with a visible cue that a spinning (or otherwise changing) reel includes or may include one or more symbols that result in or lead to a payout condition, or bonus-initiating condition, if the one or more symbols stops within the game's grid 16 and/or within a specific position of the reel's corresponding column 20 of the game's grid 16 depending on the payout scheme of the game (referred to herein as a “winning symbol” 30).

Stated differently, a reel-based wagering game method according to the present disclosure may comprise displaying spinning reels at a default spinning rate, and then reducing a spinning rate of a target reel 50 from the default spinning rate toward or to a slowed spinning rate responsive to a predetermined symbol or set of symbols of the target reel 50 being displayed or about to be displayed in a displayed game grid 16.

In some embodiments, a predefined condition may be necessary to trigger the alteration in the spinning rate (or perceived spinning rate) of a reel. That is, the predetermined symbol or set of symbols that lead to the slowed spinning rate may comprise a winning symbol 30 that, if stopped in one or more displayed symbol positions of the displayed game grid 16, results in or leads to a payout condition. As an illustrative, non-exclusive example, four out of five triggering symbols for a bonus may have been received on reels one through four of a five-reel game thereby satisfying a condition to alter the reel spin mechanics on the fifth reel while it is spinning. In other embodiments, receiving three, two, or one of the bonus triggering symbols on reel one (or reels one and two; or on reels one, two, and three) may satisfy the predefined condition so that the remaining spinning reels have alterations or modifications made to their spin mechanics. In some examples of games 10, suppose five bonus symbols are needed to trigger a second screen bonus on a five-reel game. In these examples, a triggering condition for the alteration for the spin mechanics may be receiving four bonus symbols. In one instance, a player may receive a single bonus symbol on the first reel when it stops without an immediate change to the reel spin mechanics, and then receive a stack of three bonus symbols on the second game reel when it stops. Thus, the condition for the feature has been satisfied after the second reel has stopped, and reels three, four, and five all may have their spin mechanics modified as discussed herein.

In other examples of games 10, suppose three scattered bonus symbols are needed to trigger a bonus. In these examples, a triggering condition for the alteration for the spin mechanics may be receiving a single bonus symbol. In one instance, a player may receive a first bonus symbol on the third game reel when it stops. Thus, the condition for the feature has been satisfied and reel four may have its spin mechanics modified as discussed herein. However, if a bonus symbol is not received on the fourth reel when it comes to a stop, the spin mechanics of reel five may not be altered as the triggering condition for the bonus may not be obtainable despite what lands on reel five (assuming there are no stacks of bonus symbols on reel five).

More specifically, in some examples of games 10, a spinning reel that includes one or more winning symbols is slowed (or perceived to be slowed) from a default spinning rate to or toward a slowed spinning rate at least while the winning symbol 30 is within the grid 16 (and thus displayed to a player). If the reel stops while the winning symbol 30 is within the grid 16, then an evaluation of the symbols occurs, which may result in a payout, an increased payout, an additional payout, or an initiation of a bonus game, for example, depending on the payout scheme associated with the game. If the reel does not stop while a winning symbol 30 is within the grid 16, then the reel is returned to or toward the default spinning rate when or after a winning symbol 30 is no longer within the grid 16 (and thus no longer displayed to a player). As a result, a player's attention and interest on the game may be enhanced in anticipation of a payout, an increased payout, an additional payout, or a bonus game, for example, depending on the particular payout scheme of the game.

As used herein a “spinning rate” refers to the speed (i.e., distance per time) with which a symbol 14 travels through (or is perceived to travel through) the grid 16, which in a physical reel may be the true speed of a symbol and in a virtual representation of a reel may be a virtual speed associated with the rendering of pixels that mimics the traveling of a symbol through the game's virtual grid.

In some examples of games 10, although not required, the default spinning rate may be selected such that a typical human player cannot easily distinguish or recognize symbols as they travel through the grid at the default spinning rate. In other examples of games 10, the default spinning rate may be set so that a player only catches a brief glimpse of a symbol passing through a grid. Hence, symbols may only be visible in the grid for a number of milliseconds, making them potentially difficult to distinguish, especially if a player is not paying close attention to the reel spins. As an illustrative, non-exclusive example only, a default spinning rate may result in a symbol passing through a grid in the range of 50-250 milliseconds. Default spinning rates outside of this range are within the scope of the present disclosure. Factors that may affect a selected default spinning rate include the size of the grid, the grid layout, the size of the symbols, the specific reel of a multi-reel game, the resolution of the associated display screen, etc.

In some examples of games 10, the slowed spinning rate may be selected such that a typical human player would easily distinguish or recognize symbols as they travel through the grid at the slowed spinning rate. Illustrative, non-exclusive examples of slowed spinning rates include those that are less than 90%, less than 80%, less than 70%, less than 60%, less than 50%, less than 40%, less than 30%, or less than 20% of a default spinning rate, or that are 10%-90%, 10-70%, 10%-50%, 10%-30%, 30%-90%, 30%-70%, 30%-50%, 50%-90%, 50%-70%, or 70%-90% of a default spinning rate. In addition, the duration of the reel spin (i.e., the length of time that a reel continues to spin before coming to a stop) for a reel that includes a winning symbol may be increased so that one or more instances of a winning symbol passing through the grid becomes more likely or certain to be seen by a player, thus building anticipation of a winning result. As an illustrative, non-exclusive example only, a slowed spinning rate may result in a symbol passing through a grid for a length of time greater than 250 milliseconds, including up to or even greater than one second. Slowed spinning rates outside of these values are within the scope of the present disclosure.

In some games 10, any or all reels of the game may be configured to be slowed as discussed herein. In other games 10, only a subset of the reels of the game may be configured to be slowed as discussed herein. In some games 10, only the final reel of the game may be configured to be slowed as discussed herein. In some games 10, only a reel following prior reels having stopped with symbols leading to a payout, or bonus-initiating, condition may be configured to be slowed as discussed herein. Other examples also are within the scope of the present disclosure.

In some examples of games 10, the transition from the default spinning rate to a slowed spinning rate may be instantaneous or nearly instantaneous, while in other examples of games 10, the transition from the default spinning rate to a slowed spinning rate may be gradual. In some such examples, a typical human player may perceive the gradual deceleration, while in other examples, a typical human player may not be able to perceive the gradual deceleration. In some examples, the acceleration from the slowed spinning rate back toward the default spinning rate may have the same magnitude as the deceleration from the default spinning rate toward the slowed spinning rate, although other examples may have different magnitudes of acceleration and deceleration.

In some examples of games 10, the transition from the default spinning rate toward a slowed spinning rate may initiate before a winning symbol 30 actually enters the grid. For example, the transition may be based on non-winning symbols a threshold number of positions ahead of a winning symbol 30 entering the grid, with example thresholds including (but not being limited to) one, two, three, four, or five symbol positions ahead of a winning symbol 30. In other examples of games 10, the transition from the default spinning rate toward a slowed spinning rate may only initiate upon a winning symbol 30 actually entering the grid. Similarly, in some examples of games 10, the transition back from a slowed spinning rate toward the default spinning rate may initiate before the winning symbol 30 leaves the grid, as the winning symbol 30 leaves the grid, or only after the winning symbol 30 leaves the grid, such as based on a threshold number of positions behind a winning symbol leaving the grid.

In some examples of games 10, a reel 12 including a winning symbol 30 may include a plurality of winning symbols 30, all of which may be identical to each other or which may include different winning symbols 30. That is, more than one game symbol may result in a payout condition according to a payout scheme of the game. In some such examples, the spinning rate of the reel may slow when any one of the winning symbols 30 is within the grid, while in other examples, the spinning rate of the reel may slow only when a subset of the winning symbols 30 is within the grid. As an illustrative, non-exclusive example, the spinning rate of the reel may slow only when a winning symbol that is a major symbol or bonus-initiating symbol is displayed, while the spinning rate of the reel may not slow when a winning symbol that is a minor symbol is displayed.

In some examples of games 10, a reel 12 including a winning symbol 30 may include one or more stacks of winning symbols 30 (i.e., having a reel strip that includes one or more continuous sequences of identical winning symbols 30). In such examples, not only does the slowed spinning rate give the player an anticipation of a possible payout, but the stack of winning symbols also gives the player an anticipation of a higher chance of a payout, in view of the perceived multiple opportunities for a winning symbol 30 to stop within the grid. In some implementations of games 10, stacks of winning symbols 30 may be added dynamically to a spinning reel only upon a triggering event, such as upon prior stopped reels resulting in a specific symbol or symbol combination appearing within the grid. In some implementations of games 10 with stacks of winning symbols, the change in spinning rate may be dynamic. For example, the spinning rate may gradually transition from the default spinning rate to the slowed spinning rate as the stack of winning symbols passes through the grid. Not only does this implementation catch the player's attention, but it also gives the anticipation that the reel is slowing to a stop while the stack of winning symbols is visible. In some instances, the reel may stop while one of the winning symbols is in the grid, while in other instances, the reel may speed back up toward the default spinning rate if the reel does not stop while the winning symbols are in the grid. The gradual slowing of the spinning rate of a reel may be based on the length of a stack. For example, the more winning symbols in a stack the more gradual the slowing may be and the fewer winning symbols in a stack the greater the deceleration may be.

In some examples of games 10, in addition to a reel slowing from the default spinning rate toward or to a slowed spinning rate, additional visual and/or audible elements 34 may alert a player that a winning symbol is about to enter or has entered the grid, so that the player's attention is drawn to the slowed reel and the anticipation of a winning symbol stopping within the grid.

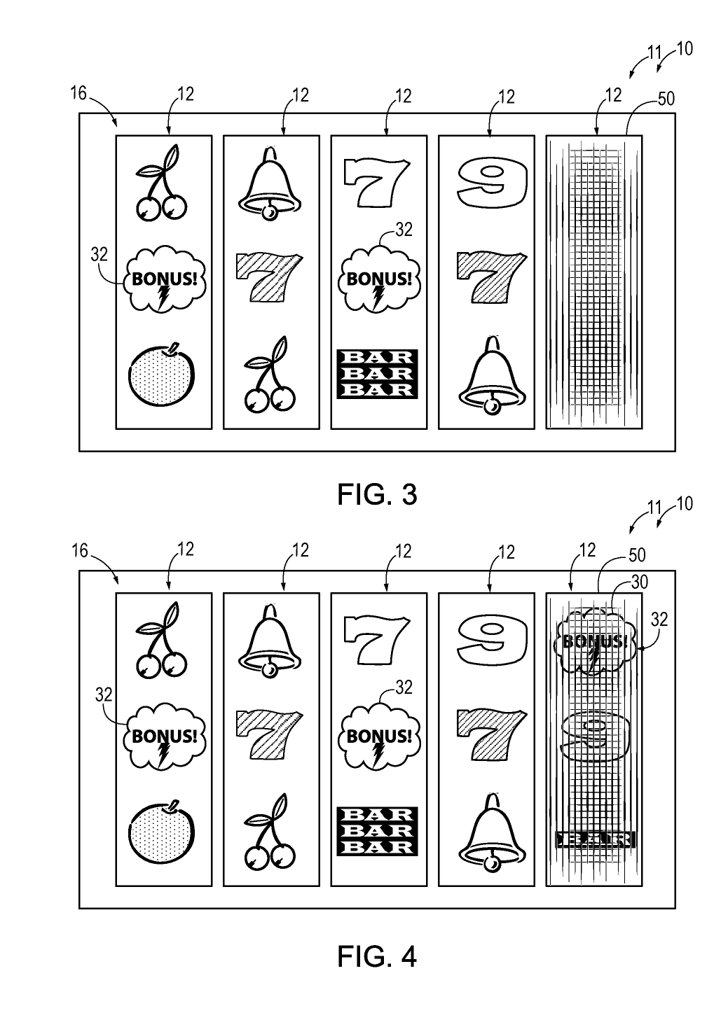

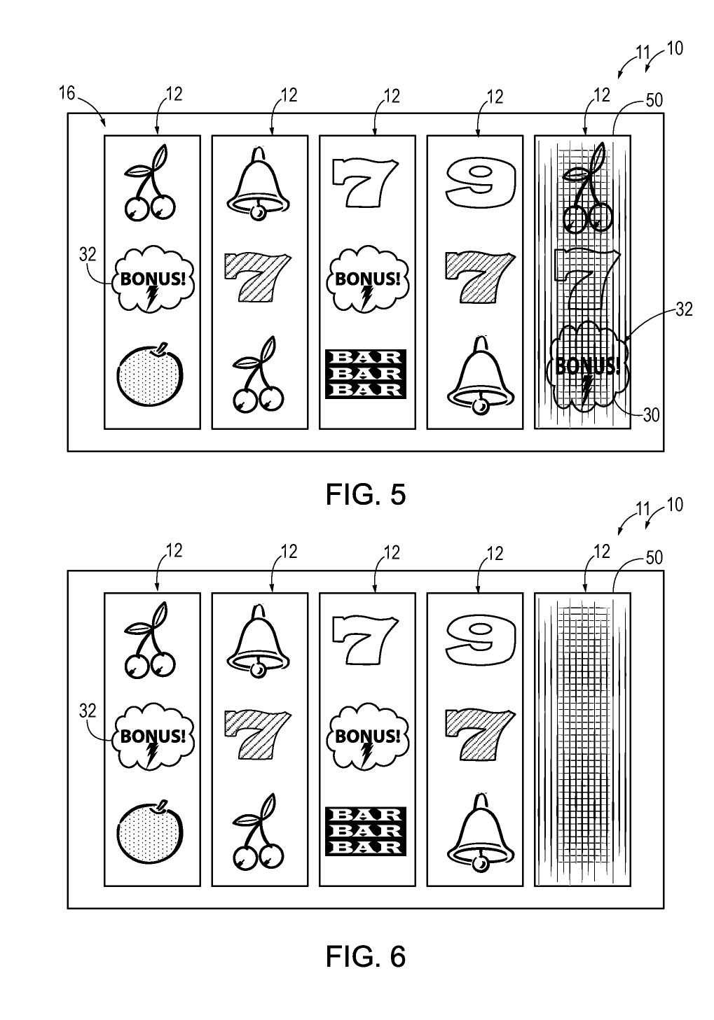

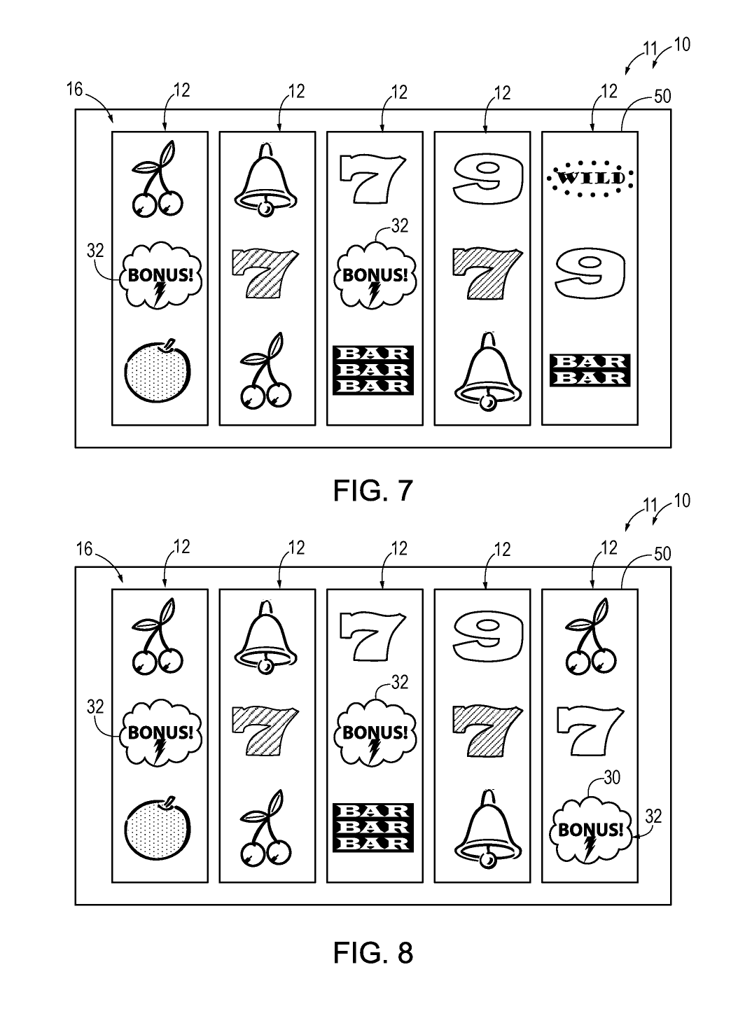

Referring to the drawings, FIGS. 2-7 illustrate an example implementation of games 10 based on a scatter pay scheme associated with a bonus symbol 32 initiating a bonus game when the bonus symbol 32 stops in any position on all three of the first, third, and fifth reels 12. Specifically, the sequence of FIGS. 2-3 relate to the first four reels having stopped with the bonus symbol 32 displayed on the first and third reels and with the fifth reel (i.e., a target reel 50) spinning at a default spinning rate. In FIGS. 4-5, the fifth reel has slowed to or toward a slowed spinning rate as the bonus symbol 32, which in this example is a winning symbol 30, as defined herein, is within the grid 16. FIG. 6 illustrates the fifth reel having returned to the default spinning rate in view of the bonus symbol 30 having left the grid, and FIG. 7 illustrates the fifth reel in a stopped state without the winning symbol having stopped within the grid, and thus without a bonus game being initiated. On the other hand, the sequence of FIGS. 2-5 and 8 illustrate an example implementation in which the bonus symbol 32 on the fifth reel stopped within the grid 16, thereby initiating bonus game.

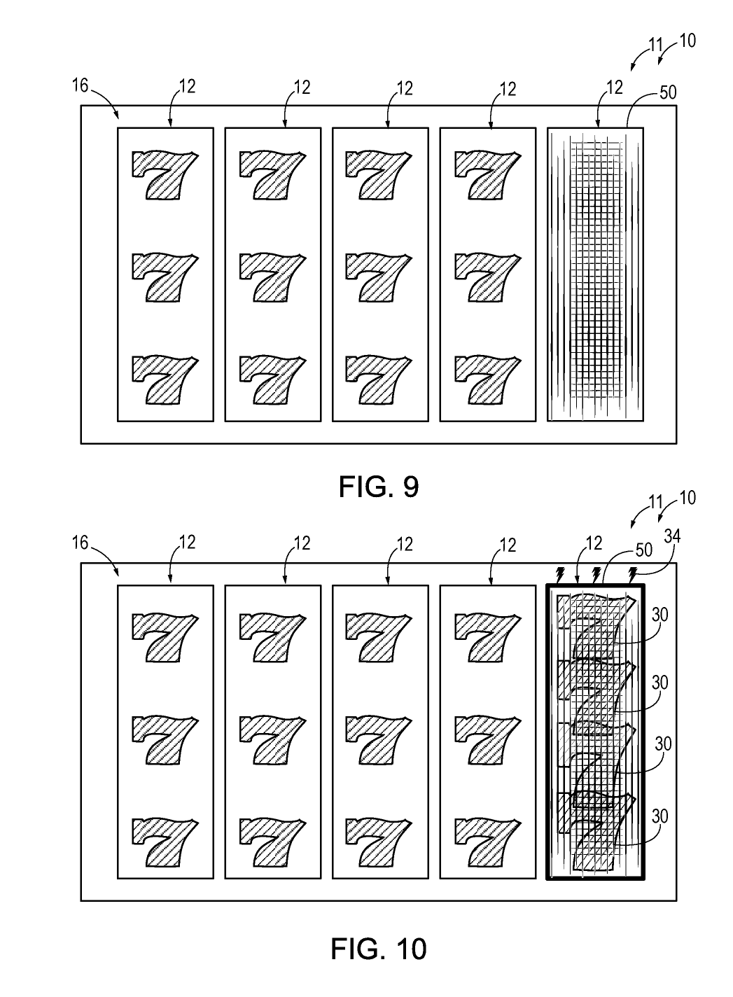

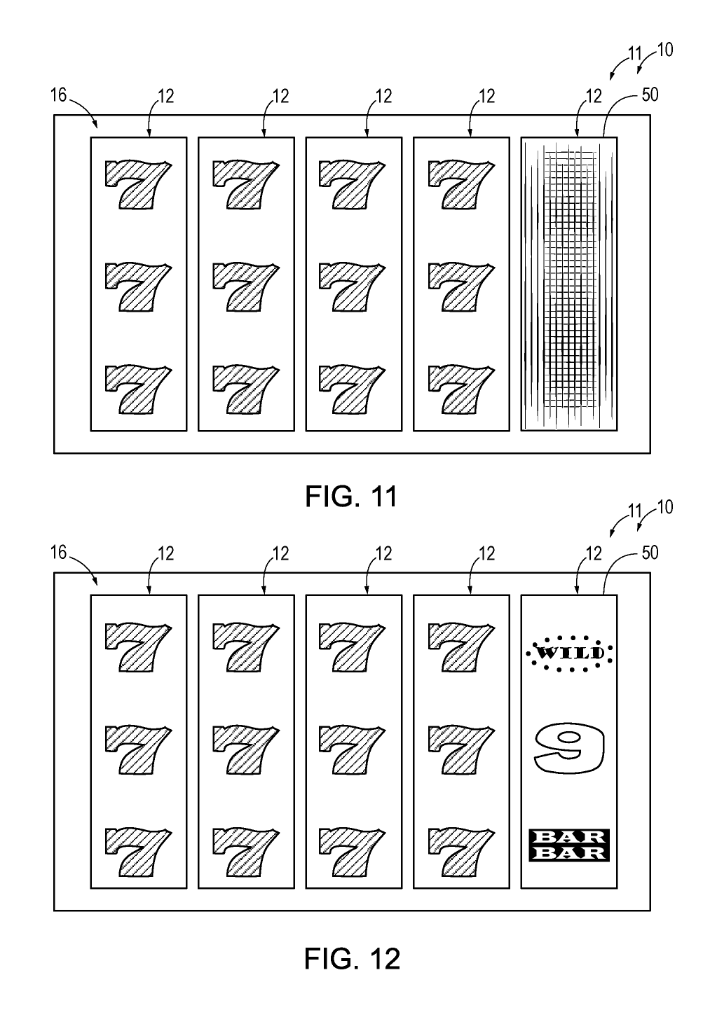

The sequence of FIGS. 2 and 9-12 illustrate an example implementation of games 10 in which a stack of matching symbols have stopped within the grid 16 on the first through fourth reels 12. In FIG. 9, the fifth reel (i.e., the target reel 50) continues to spin at the default spinning rate, while in FIG. 10, the fifth reel has slowed to or toward a slowed spinning rate and a visual alert 34 in the form of lightning bolts is displayed due to a stack of winning symbols 30 matching the stopped symbols of the first through fourth reels 12 having entered the grid 16. In FIG. 11, the fifth reel has returned to the default spinning rate due to the stack of winning symbols 30 having left the grid 16, and finally in FIG. 12, the fifth reel has stopped without any winning symbols on the fifth reel present in the grid 16, and thus without the fifth reel contributing to a payout.

The sequence of FIGS. 2 and 9-11 and 13-14, on the other hand, results in the stack of winning symbols 30 coming to a stop within the grid and thus contributing to a payout with the first through fourth reels 12.

In addition to or an as alternative to triggering the slowing of a reel 12 from a default spinning rate to or toward a slowed spinning rate based on a winning symbol 30 entering the grid 16, games 10 may be implemented such that a reel 12 slows from the default spinning rate to or toward the slowed spinning rate based on a predetermined section, or span of symbols, on the reel 12 entering (or about to enter) the grid 16. As illustrative, non-exclusive examples, such a predetermined section may include 10-50, 10-40, 10-30, 10-20, 20-50, 20-40, 20-30, 30-50, 30-40, or 40-50 symbols of a reel having greater than 50 total symbols. Moreover, such a predetermined section may or may not include a winning symbol 30. Stated differently, while the target reel 50 may have a winning symbol 30, the predetermined symbol or set of symbols that result in the target reel 50 slowing toward the slowed spinning rate may not comprise the winning symbol. Accordingly, when the target reel slows to or toward the slowed spinning rate, a player's attention will be drawn to the slowed reel in anticipation of seeing a winning symbol and will focus to try and see a winning symbol. In examples where the predetermined section does include a winning symbol, the player will see it enter the grid and know that at least one winning symbol is present on the reel and anticipate the reel stopping with the winning symbol visible. Even if the winning symbol passes through the grid, and if the reel does not stop while slowed, and instead returns to the default spinning rate, the player will know that a winning symbol is on its way again around the reel and toward the grid, thereby anticipating a potential payout, additional payout, or increased payout, depending on the payout scheme of the game. In examples where the predetermined section does not include a winning symbol, the player will be drawn to the target reel in anticipation of seeing a winning symbol, even if one does not appear when the target reel is at the slowed spinning rate.

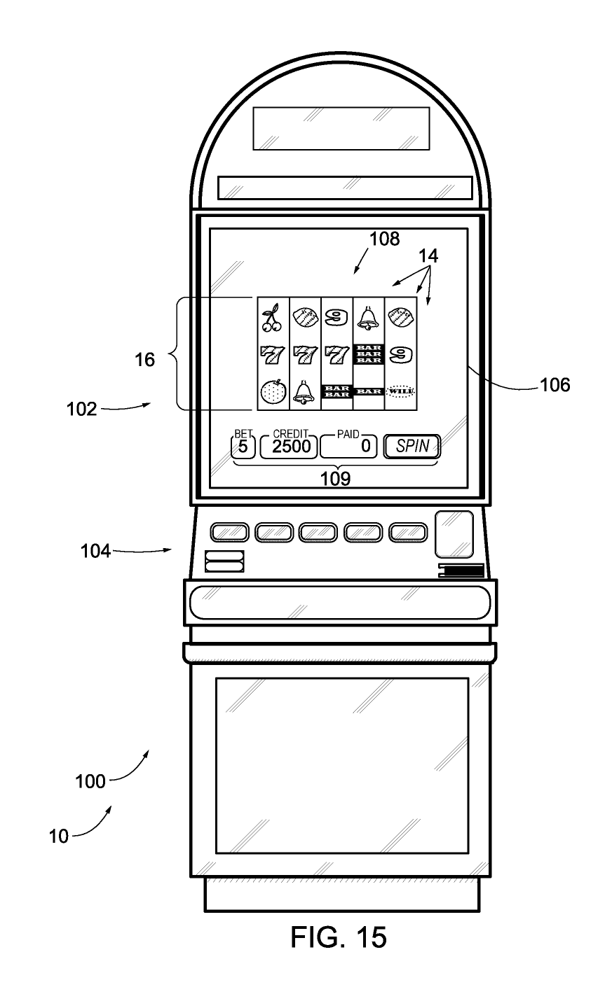

Turning now to FIG. 15, an example gaming apparatus 100 that may embody a game 10 and implement a method according to the present disclosure is depicted. The gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 14 such as associated with games 10, and an operations portion 109 that can include meters, various game buttons, or other game information for a player of the gaming apparatus 100.

The user interface 104 allows the user to control and engage in play of the gaming apparatus 100 and thus of games 10. The particular user interface mechanisms included with user interface 104 may be dependent on the type of gaming device. For example, the user interface 104 may include one or more buttons, switches, joysticks, levers, pull-down handles, trackballs, voice-activated input, touch screens (including, e.g., the game display 102), or any other user input system or mechanism that allows the user to play the particular gaming activity.

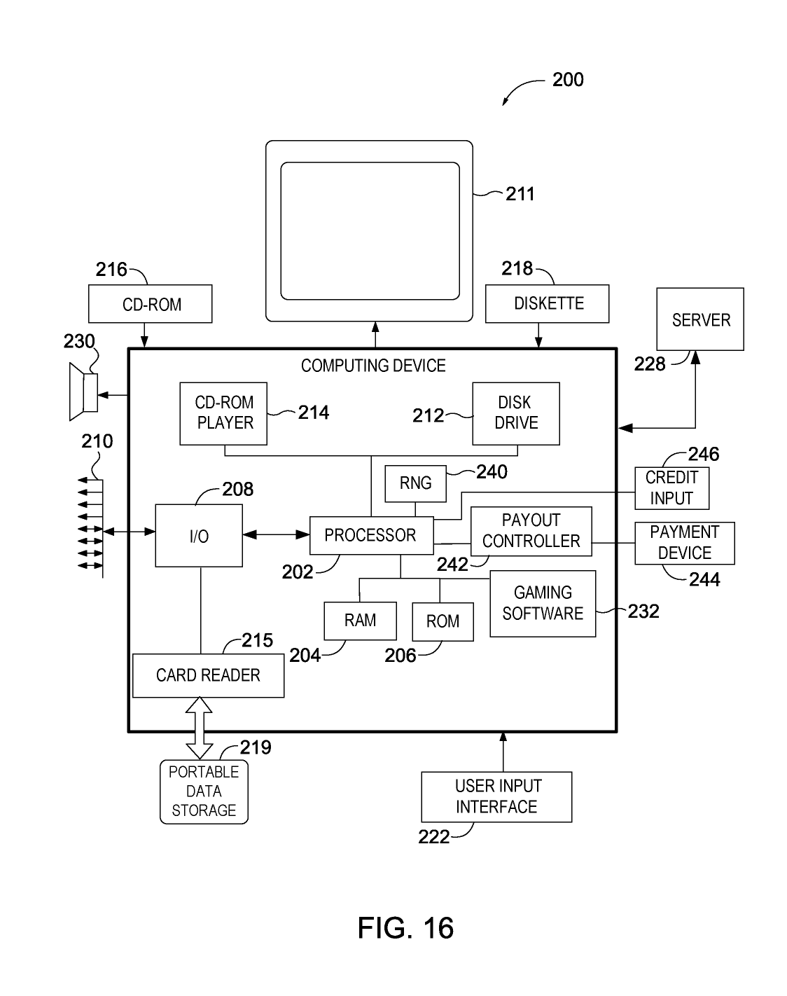

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 16. For example, currency input mechanisms, card readers, credit card readers, smart card readers, punch card readers, radio frequency identifier (RFID) readers, and other mechanisms may be used to enter wagers. The user interface 104 also may include a mechanism to read and/or validate player loyalty information to identify a user or player of the gaming device. This mechanism may be a card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with games 10 and gaming apparatus 100, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In connection with games 10, the primary gaming portion 108 may display grid 16 (or an equivalent arrangement) of game symbols 14.

The primary gaming portion 108 may include other features known in the art that facilitate gaming, such as operations portion 109. As is generally known in the art, the operations portion 109 provides information about current bets, current wins, remaining credits, etc. associated with gaming activities of the grid 16 of game symbols 14. The operations portion 109 also may provide touchscreen controls for facilitating game play. The grid 16 also may include touchscreen features, such as facilitating selection of individual symbols, or user controls over stopping or spinning/changing reels. The game display 106 of the display area 102 may include other features that are not shown, such as paytables, navigation controls, etc.

Although FIG. 15 illustrates a particular implementation of a gaming apparatus 100 that embodies a game 10 in the form of a casino or electronic gaming machine (“EGM”), one or more devices may be programmed to play various embodiments of games 10. That is, games 10 may be implemented, as shown in FIG. 15, as a casino gaming machine or other special purpose gaming kiosk as described herein, or may be implemented via computing systems operating under the direction of local gaming software, and/or remotely-provided software such as provided by an application service provider (ASP). Casino gaming machines also may utilize computing systems to control and manage the gaming activity, although these computing systems typically include specialized components and/or functionality to operate the particular elements of casino gaming machines. Additionally, computing systems operating over networks, such as the Internet, also may include specialized components and/or functionality to operate elements particular to these systems, such as random number generators. An example of a representative computing system capable of carrying out operations in accordance with games 10 is illustrated in FIG. 16.

Hardware, firmware, software or a combination thereof may be used to perform the various gaming functions, display presentations and operations described herein. The functional modules used in connection with games 10 may reside in a gaming machine as described, or may alternatively reside on a stand-alone or networked computer. The computing structure 200 of FIG. 16 (also referred to as a computing arrangement and a computing device) is an example computing structure that may be used in connection with such electronic gaming machines, computers, or other computer-implemented devices to carry out operations of games 10. Although numerous components or elements are shown as part of this computing structure 200 in FIG. 16, additional or fewer components may be utilized in particular implementations of games 10.

The example computing arrangement 200 suitable for performing the gaming functions in accordance with games 10 typically includes a central processor (CPU) 202 coupled to random access memory (RAM) 204 and some variation of read-only memory (ROM) 206. Processor 202, either alone or together with one or more additional components of a computing arrangement, may be described as a controller. The ROM 206 also may represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 also may include one or more data storage devices, including hard and floppy disk drives 212, CD-ROM drives 214, a card reader 215, and other hardware capable of reading and/or storing information such as DVDs, etc. In one embodiment, software for carrying out the operations in accordance with games 10 may be stored and distributed on a CD-ROM 216, diskette 218, or portable data storage 219, such as in the form of an access card, or other form of computer readable media capable of portably storing information. These storage media may be inserted into, and read by, devices such as the CD-ROM drive 214, the disk drive 212, card reader 215, etc. The software also may be transmitted to the computing arrangement 200 via data signals, such as being downloaded electronically via a network, such as a local area network (e.g., a casino, property, or bank network) or a wide area network (e.g., the Internet). Further, as previously described, the software for carrying out the functions associated with games 10 alternatively may be stored in internal memory/storage of the computing device 200, such as in the ROM 206.

The computing arrangement 200 is coupled to the display 211, which represents a display on which the gaming activities in accordance with games 10 are presented. The display 211 represents the “presentation” of the game information in accordance with games 10, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, such as a gaming apparatus 100, the display 211 corresponds to the game display 106 of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 also may act as a user input device, e.g., where the display 211 is a touchscreen device. In some embodiments, where the computing device 200 is implemented in a personal computer, tablet, smart phone, or other consumer electronic device, the user interface and display may be the available input/output mechanisms related to those devices.

Chance-based gaming systems such as slot machines, in which games 10 are applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. Games 10 are operable using any known RNG, and may be integrally programmed as part of the processor 202 operation, or alternatively may use a separate RNG controller 240. The RNGs often are protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with games 10 and may interact with the player via one or more networks. The computing arrangement 200 also may be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 also may include a payout controller 242 configured to receive a signal from the processor 202 indicating a payout is to be made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 also may be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 also may include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 (also referred to as credit input 246) represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences generally are controlled by gaming software 232 that controls a primary gaming activity of the computing arrangement 200. The gaming software 232 may be temporarily loaded into RAM 204, and may be stored locally using any combination of ROM 206, drives 212, CD ROM drives 214, flash drives, or other non-transitory computer-readable storage media known in the art. The primary gaming software 232 also may be accessed remotely, such as via the server 228 or the Internet.

The primary gaming software 232 in the computing arrangement 200 may be an application software module. According to embodiments of games 10, this software 232 provides a slot game or similar game of chance as described hereinabove. For example, the software 232 may present, by way of the display 211, representations of symbols to map or otherwise display as part of a slot-based game having reels, such as games 10. However, in other embodiments, the principles of this concept may be applied to poker games or other types of games of chance. Symbols appearing in one or more predefined combinations of symbol positions may be evaluated to determine awards based on a paytable. The software 232 may include instructions to provide other functionality as known in the art or as described and shown herein.

Illustrative, non-exclusive examples of inventive subject matter according to the present disclosure are described in the following enumerated paragraphs:

A. A reel-based wagering game method implemented on a gaming apparatus comprising a game display, a user interface, and a controller, the reel-based wagering game method comprising:

displaying, by the game display, spinning reels at a default spinning rate; and

reducing, by the controller, a spinning rate of a target reel of the spinning reels from the default spinning rate toward or to a slowed spinning rate responsive to a predetermined symbol or set of symbols of the target reel being displayed or about to be displayed in a displayed game grid.

A1. The reel-based wagering game method of paragraph A,

wherein the predetermined symbol or set of symbols comprises a winning symbol; and

wherein the winning symbol, if stopped in one or more displayed symbol positions of the displayed game grid, results in or leads to a payout condition.

A1.1. The reel-based wagering game method of paragraph A1, wherein the target reel has a continuous sequence of more than one of the winning symbol.

A1.2. The reel-based wagering game method of any of paragraphs A1-A1.1, further comprising:

altering, by the controller, the target reel to have a continuous sequence of more than one of the winning symbol, responsive to a triggering event associated with reels stopped prior to the target reel.

A1.3. The reel-based wagering game method of any of paragraphs A1-A1.2, further comprising:

alerting, by the gaming apparatus, a player that the target reel has the winning symbol.

A1.3.1. The reel-based wagering game method of paragraph A1.3, wherein the alerting comprises one or both of:

audibly alerting; and

visually alerting, by the game display.

A1.4. The reel-based wagering game method of any of paragraphs A1-A1.3.1,

wherein the winning symbol is a first winning symbol and the payout condition is a first payout condition;

wherein the target reel has a second winning symbol that is different from the first winning symbol and that, if stopped in one or more displayed symbol positions of the displayed game grid, results in or leads to a second payout condition; and

wherein the spinning rate of the target reel is not reduced from the default spinning rate toward or to the slowed spinning rate responsive to the second winning symbol being displayed or about to be displayed.

A2. The reel-based wagering game method of paragraph A,

wherein the target reel has a winning symbol that, if stopped in one or more displayed symbol positions of the displayed game grid, results in or leads to a payout condition; and

wherein the predetermined symbol or set of symbols does not comprise the winning symbol.

A3. The reel-based wagering game method of any of paragraphs A-A2, wherein the slowed spinning rate is less than 90% of the default spinning rate.

A4. The reel-based wagering game method of any of paragraphs A-A3, wherein at the slowed spinning rate, gaming symbols of the target reel are recognizable by a typical human player.

A5. The reel-based wagering game method of any of paragraphs A-A4, wherein at the default spinning rate, gaming symbols of the target reel are not recognizable by a typical human player.

A6. The reel-based wagering game method of any of paragraphs A-A5, wherein at the slowed spinning rate, individual game symbols of the target reel are displayed for greater than 250 milliseconds as they pass through the displayed game grid.

A7. The reel-based wagering game method of any of paragraphs A-A6, further comprising:

maintaining, by the controller, the target reel as a spinning reel for a period of time longer than non-target reels.

A8. The reel-based wagering game method of any of paragraphs A-A7, further comprising:

sequentially stopping, by the controller, the spinning reels to display, by the game display, stopped reels, wherein each stopped reel comprises displayed game symbols;

wherein the target reel is a last of the spinning reels to stop.

A9. The reel-based wagering game method of any of paragraphs A-A8, further comprising:

sequentially stopping, by the controller, the spinning reels to display, by the game display, stopped reels, wherein each stopped reel comprises displayed game symbols; and

evaluating, by the controller, whether the displayed game symbols of X−1 stopped reels lead to a/the payout condition, wherein X is an integer corresponding to a threshold number of reels to result in the payout condition;

wherein the target reel is the Xth stopped reel that can lead to the payout condition.

B. A gaming apparatus configured to implement a reel-based wagering game, the gaming apparatus comprising:

a game display configured to display at least a portion of game reels of the reel-based wagering game;

a user interface configured to receive user input for controlling and engaging with the reel-based wagering game;

a wager input device structured to receive physical currency or currency based structure, the currency or currency based structure establishing a credit balance, the credit balance being increasable and decreasable based at least on wagering activity received from a player via the user interface;

a cashout device configured to receive an input to cause an initiation of a payout associated with the credit balance; and

a controller operably coupled to the game display, the user interface, the wager input device, and the cashout device, wherein the controller is operable to:

cause the game display to display spinning reels at a default spinning rate; and

reduce a spinning rate of a target reel of the spinning reels from the default spinning rate toward or to a slowed spinning rate responsive to a predetermined symbol or set of symbols of the target reel being displayed or about to be displayed in a displayed game grid.

B1. The gaming apparatus of paragraph B,

wherein the predetermined symbol or set of symbols comprises a winning symbol; and

wherein the winning symbol, if stopped in one or more displayed symbol positions of the displayed game grid, results in or leads to a payout condition.

B1.1. The gaming apparatus of paragraph B1, wherein the target reel has a continuous sequence of more than one of the winning symbol.

B1.2. The gaming apparatus of any of paragraphs B1-B1.1, wherein the controller is further operable to:

alter the target reel to have a continuous sequence of more than one of the winning symbol, responsive to a triggering event associated with reels stopped prior to the target reel.

B1.3. The gaming apparatus of any of paragraphs B1-B1.2, wherein the controller is further operable to:

cause the gaming apparatus to alert a player that the target reel has the winning symbol.

B1.3.1. The gaming apparatus of paragraph B1.3, wherein the controller is operable to cause the gaming apparatus to one or both of:

audibly alert the player that the target reel has the winning symbol; and

visually alert, by the game display, the player that the target reel has the winning symbol.

B1.4. The gaming apparatus of any of paragraphs B1-B1.3.1,

wherein the winning symbol is a first winning symbol and the payout condition is a first payout condition;

wherein the target reel has a second winning symbol that is different from the first winning symbol and that, if stopped in one or more displayed symbol positions of the displayed game grid, results in or leads to a second payout condition; and

wherein the spinning rate of the target reel is not reduced by the controller from the default spinning rate toward or to the slowed spinning rate responsive to the second winning symbol being displayed or about to be displayed.

B2. The gaming apparatus of paragraph B,

wherein the target reel has a winning symbol that, if stopped in one or more displayed symbol positions of the displayed game grid, results in or leads to a payout condition; and

wherein the predetermined symbol or set of symbols does not comprise the winning symbol.

B3. The gaming apparatus of any of paragraphs B-B2, wherein the slowed spinning rate is less than 90% of the default spinning rate.

B4. The gaming apparatus of any of paragraphs B-B3, wherein at the slowed spinning rate, gaming symbols of the target reel are recognizable by a typical human player.

B5. The gaming apparatus of any of paragraphs B-B4, wherein at the default spinning rate, gaming symbols of the target reel are not recognizable by a typical human player.

B6. The gaming apparatus of any of paragraphs B-B5, wherein at the slowed spinning rate, individual game symbols of the target reel are displayed for greater than 250 milliseconds as they pass through the displayed game grid.

B7. The gaming apparatus of any of paragraphs B-B6, wherein the controller is further operable to:

maintain the target reel as a spinning reel for a period of time longer than non-target reels.

B8. The gaming apparatus of any of paragraphs B-B7, wherein the controller is further operable to:

sequentially stop the spinning reels to cause the game display to display stopped reels, wherein each stopped reel comprises displayed game symbols;

wherein the target reel is a last of the spinning reels to stop.

B9. The gaming apparatus of any of paragraphs B-B8,

wherein the controller is further operable to:
sequentially stop the spinning reels to cause the game display to display stopped reels, wherein each stopped reel comprises displayed game symbols; and
evaluate whether the displayed game symbols of X−1 stopped reels lead to a/the payout condition, wherein X is an integer corresponding to a threshold number of reels to result in the payout condition; and

wherein the target reel is the Xth stopped reel that can lead to the payout condition.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A reel-based wagering game method implemented on a gaming apparatus comprising a game display, a user interface, and a controller, the reel-based wagering game method comprising:
displaying, by the game display, spinning reels at a default spinning rate; and
reducing, by the controller, a spinning rate of a target reel of the spinning reels from the default spinning rate toward or to a slowed spinning rate responsive to a predetermined symbol or set of symbols of the target reel being displayed or about to be displayed in a displayed game grid.

2. The reel-based wagering game method of claim 1,
wherein the predetermined symbol or set of symbols comprises a winning symbol; and
wherein the winning symbol, if stopped in one or more displayed symbol positions of the displayed game grid, results in or leads to a payout condition.

3. The reel-based wagering game method of claim 2, wherein the target reel has a continuous sequence of more than one of the winning symbol.

4. The reel-based wagering game method of claim 2, further comprising:
altering, by the controller, the target reel to have a continuous sequence of more than one of the winning symbol, responsive to a triggering event associated with reels stopped prior to the target reel.

5. The reel-based wagering game method of claim 2, further comprising:
alerting, by the gaming apparatus, a player that the target reel has the winning symbol.

6. The reel-based wagering game method of claim 2,
wherein the winning symbol is a first winning symbol and the payout condition is a first payout condition;
wherein the target reel has a second winning symbol that is different from the first winning symbol and that, if stopped in one or more displayed symbol positions of the displayed game grid, results in or leads to a second payout condition; and
wherein the spinning rate of the target reel is not reduced from the default spinning rate toward or to the slowed spinning rate responsive to the second winning symbol being displayed or about to be displayed.

7. The reel-based wagering game method of claim 1,
wherein the target reel has a winning symbol that, if stopped in one or more displayed symbol positions of the displayed game grid, results in or leads to a payout condition; and
wherein the predetermined symbol or set of symbols does not comprise the winning symbol.

8. The reel-based wagering game method of claim 1, wherein the slowed spinning rate is less than 90% of the default spinning rate.

9. The reel-based wagering game method of claim 1, wherein at the slowed spinning rate, individual game symbols of the target reel are displayed for greater than 250 milliseconds as they pass through the displayed game grid.

10. The reel-based wagering game method of claim 1, further comprising:
maintaining, by the controller, the target reel as a spinning reel for a period of time longer than non-target reels.

11. The reel-based wagering game method of claim 1, further comprising:
sequentially stopping, by the controller, the spinning reels to display, by the game display, stopped reels, wherein each stopped reel comprises displayed game symbols;
wherein the target reel is a last of the spinning reels to stop.

12. The reel-based wagering game method of claim 1, further comprising:
sequentially stopping, by the controller, the spinning reels to display, by the game display, stopped reels, wherein each stopped reel comprises displayed game symbols; and
evaluating, by the controller, whether the displayed game symbols of X−1 stopped reels lead to a payout condition, wherein X is an integer corresponding to a threshold number of reels to result in the payout condition;
wherein the target reel is the Xth stopped reel that can lead to the payout condition.

13. A gaming apparatus configured to implement a reel-based wagering game, the gaming apparatus comprising:
a game display configured to display at least a portion of game reels of the reel-based wagering game;
a user interface configured to receive user input for controlling and engaging with the reel-based wagering game;
a wager input device structured to receive physical currency or currency based structure, the currency or currency based structure establishing a credit balance, the credit balance being increasable and decreasable based at least on wagering activity received from a player via the user interface;
a cashout device configured to receive an input to cause an initiation of a payout associated with the credit balance; and
a controller operably coupled to the game display, the user interface, the wager input device, and the cashout device, wherein the controller is operable to:
cause the game display to display spinning reels at a default spinning rate; and
reduce a spinning rate of a target reel of the spinning reels from the default spinning rate toward or to a slowed spinning rate responsive to a predetermined symbol or set of symbols of the target reel being displayed or about to be displayed in a displayed game grid.

14. The gaming apparatus of claim 13,
wherein the predetermined symbol or set of symbols comprises a winning symbol; and
wherein the winning symbol, if stopped in one or more displayed symbol positions of the displayed game grid, results in or leads to a payout condition.

15. The gaming apparatus of claim 14, wherein the target reel has a continuous sequence of more than one of the winning symbol.

16. The gaming apparatus of claim 14, wherein the controller is further operable to:
alter the target reel to have a continuous sequence of more than one of the winning symbol, responsive to a triggering event associated with reels stopped prior to the target reel.

17. The gaming apparatus of claim 14, wherein the controller is further operable to:
cause the gaming apparatus to alert a player that the target reel has the winning symbol.

18. The gaming apparatus of claim 14,
wherein the winning symbol is a first winning symbol and the payout condition is a first payout condition;
wherein the target reel has a second winning symbol that is different from the first winning symbol and that, if stopped in one or more displayed symbol positions of the displayed game grid, results in or leads to a second payout condition; and
wherein the spinning rate of the target reel is not reduced by the controller from the default spinning rate toward or to the slowed spinning rate responsive to the second winning symbol being displayed or about to be displayed.

19. The gaming apparatus of claim 13,
wherein the target reel has a winning symbol that, if stopped in one or more displayed symbol positions of the displayed game grid, results in or leads to a payout condition; and
wherein the predetermined symbol or set of symbols does not comprise the winning symbol.

20. The gaming apparatus of claim 13, wherein the slowed spinning rate is less than 90% of the default spinning rate.

21. The gaming apparatus of claim 13, wherein at the slowed spinning rate, individual game symbols of the target reel are displayed for greater than 250 milliseconds as they pass through the displayed game grid.

22. The gaming apparatus of claim 13, wherein the controller is further operable to:
maintain the target reel as a spinning reel for a period of time longer than non-target reels.

23. The gaming apparatus of claim 13, wherein the controller is further operable to:
sequentially stop the spinning reels to cause the game display to display stopped reels, wherein each stopped reel comprises displayed game symbols;
wherein the target reel is a last of the spinning reels to stop.

24. The gaming apparatus of claim 13,
wherein the controller is further operable to:
sequentially stop the spinning reels to cause the game display to display stopped reels, wherein each stopped reel comprises displayed game symbols; and
evaluate whether the displayed game symbols of X−1 stopped reels lead to a payout condition, wherein X is an integer corresponding to a threshold number of reels to result in the payout condition; and
wherein the target reel is the Xth stopped reel that can lead to the payout condition.
